(19) United States
(12) Patent Application Publication
(10) Pub. No.: US 2015/0349369 A1
(43) Pub. Date: Dec. 3, 2015

(54) High-Energy-Density, Nonaqueous, Redox Flow Batteries Having Iodine-based Species

(71) Applicant: BATTELLE MEMORIAL INSTITUTE, Richland, WA (US)

(72) Inventors: Bin Li, Richland, WA (US); Xiaoliang Wei, Richland, WA (US); Zimin Nie, Richland, WA (US); Wei Wang, Kennewick, WA (US); Jun Liu, Richland, WA (US); Vincent L. Sprenkle, Richland, WA (US)

(73) Assignee: BATTELLE MEMORIAL INSTITUTE, Richland, WA (US)

(21) Appl. No.: 14/294,391

(22) Filed: Jun. 3, 2014

(51) Int. Cl. H01M 8/18; H01M 8/04; H01M 8/22; H01M 8/10

(52) U.S. Cl. CPC H01M 8/188; H01M 8/1009; H01M 8/04186; H01M 8/225; H01M 8/22

(57) ABSTRACT

Nonaqueous redox flow batteries (RFBs) can utilize a metal and a cation of the metal (Mⁿ⁺) as an active redox couple for a first electrode and electrolyte, respectively, in a first half-cell. The RFBs can also utilize a second electrolyte having I-based species. The I-based species can be selected from the group consisting of I⁻ anions, I₂, anions of Iₓ (x≧3), or combinations thereof. Two different ones of the I-based species compose a second redox active couple in the second half cell.

### STATEMENT REGARDING FDERALLY SONSORED RESEARCH OR DEVELOPMENT

This invention was made with Government support under Contract DE-AC0576RL01830 awarded by the U.S. Department of Energy. The Government has certain rights in the invention.

### BACKGROUND

High energy density and high energy efficiency are critical qualities for increasing success in renewable clean energy applications. Redox flow batteries (RFBs) can meet many needs by providing conversion between electrical energy and chemical energy. Many redox flow batteries utilize aqueous chemistries, including all-vanadium, iron-chromium, iron vanadium, and polysulfide-bromine RFBs, which are confined to a narrow voltage window to avoid water electrolysis. They are also limited to relatively low electrolyte concentrations because of solubility limits. Accordingly, most of the traditional aqueous RFBs have been low-energy-density systems.

For example, the energy density of a traditional all-vanadium redox flow battery is in the range of approximately 20-50 Wh/L depending on the choice of electrolyte. Traditional zinc-based flow batteries, such as a Zn—Br flow battery (ZBB), demonstrate slightly higher values of energy density. However, the performance of common ZBBs is often limited by their low energy efficiency and short cycling life. Furthermore, the bromine is very corrosive and hazardous, leading to serious health and environmental concerns. The low energy density not only limits the application of flow batteries to stationary energy storage, but also increases the cost of the flow battery.

Nonaqueous electrolyte solutions can provide a broadened voltage window (e.g., greater than 2V), which can increase the energy density of the flow battery system. However, the solubility of metal-containing compounds in nonaqueous solvents can be very low, which results in low active material concentration in traditional RFBs. Furthermore, nonaqueous chemistries can involve certain unwanted side reactions that limit performance and/or present safety hazards. Based on the relatively low performance of state-of-the-art RFBs, a need exists for improved RFBs having higher energy density at lower costs.

### SUMMARY

Described herein are nonaqueous redox flow batteries (RFBs) that can be operated at high cell voltages and, therefore, can exhibit high energy and power densities compared to conventional RFBs. The instant nonaqueous RFBs can have an active redox couple comprising a metal (M) and cations of M in a first half cell. The second half cell has an electrolyte comprising metal iodide (MIₙ) in a nonaqueous supporting solution. Taking advantage of the low redox potential of the first half-cell electrode, which contains M, and the second half-cell electrolyte, which contains at least two different iodine-based (I-based) species as a redox active couple, the flow battery is expected to demonstrate high cell voltage and thus high power and energy densities, while keeping the unique attributes of flow battery systems such as decoupled energy and power, scalability, and modularity. For example, described herein are nonaqueous RFBs having energy density values that are greater than 60 Wh/L, or even 100 Wh/L.

Disclosed herein are energy storage devices comprising a first half cell and a second half cell. The first half cell comprises a solid or molten first electrode comprising a metal (M). M and cations of M compose a first redox active couple at the first half cell. Examples of M can include, but are not limited to Li, Na, K, Cs, Mg, Ca, Ba, Al, Zn, Ga, Fe, Cr, Ti, and any combination thereof. The second half cell is configured as a flow cell connected to a source of a second nonaqueous electrolyte solution. The electrolyte solution comprises I-based species and cations of M. The I-based species are selected from the group consisting of I⁻ anions, anions of Iₓ (x≧3), I₂, or combinations thereof. Two different ones of the I-based species compose a second redox active couple in the second half cell. A porous separator or ion exchange membrane is arranged between the first and second half cells.

The first half cell can further comprise a first nonaqueous electrolyte solution in which the cations of M are dissolved. Preferably, the first nonaqueous electrolyte solution and the second nonaqueous electrolyte solution are substantially the same solution and/or are sourced from a common solution. Accordingly, in some embodiments, the energy storage device has a prior-to-charge state in which the first and second nonaqueous electrolyte solutions comprise substantially equal concentrations of cations of M and comprise substantially equal concentrations of I-based species. After charging and discharging, the concentrations of cations of M and/or I-based species in the first electrolyte solution might differ from that in the second electrolyte solution. Embodiments in which the first half cell comprises a first nonaqueous electrolyte solution, the first half cell can be configured as a flow cell connected to a source of the first nonaqueous electrolyte solution.

In some embodiments, the solid first electrode comprises a slurry having particles of solid M in the first nonaqueous electrolyte solution. In some variations, the first half cell can be configured as a flow cell and can be connected to a source of the slurry.

As used herein, the charge carrier species can refer to typically one or more species of the cations of M, which balances electron flow during operation of the energy storage device. However, the charge carrier species can comprise a charged species that differs from M. In some instances, the charge carrier species can comprise an anion. For example, cells having a porous separator between the two half-cells can utilize charge carrier species including anions. In preferred embodiments, protons are not the charge carrier species.

Disclosed herein are energy storage devices that do not utilize solid state electrolytes, or ion conductive materials, as a separation between the first and second half cells. Examples of solid state electrolytes, or ion conductive materials can include ceramic solid electrolyte materials. Preferably, the separation is achieved using a porous separator or porous membrane material. Solid state electrolytes and ion conductive materials are not typically used in porous forms. Examples of the membrane can include, but are not limited to, ion-exchange membranes, polymer membranes, and solid-state membranes that comprise polymers, sulfonated tetrafluoroethylene based fluoropolymer-copolymers, and ceramics. Examples of the separator can include, but are not limited to, nano- and micro-porous separators that comprise polymers, ceramics, glasses or other materials.

Also disclosed herein are energy storage devices that can further comprise a conduit connecting the first and second half cells and a flow controller for electrolyte maintenance. The conduit and flow controller can be configured to permit or restrict circulation of electrolyte from the second half cell to the first half cell. Electrolyte that is circulated to the second half cell to the first can react with the first solid or molten electrode. For example, the I₂ and/or the anions of Iₓ (where x≧3) can oxidize the metal into metal cations and correspondingly I₂ and/or anions of Iₓ (where x≧3) are reduced toward I⁻. Consequently, the electrolytes at both sides can be recovered to compositions similar to the original electrolytes (e.g. aqueous MI solutions).

Energy storage devices described herein can exhibit experimental discharge energy densities greater than 60 Wh/L. The experimental discharge energy can even exceed 100 Wh/L. The electrochemical activity of the metal-containing redox active couple and the redox active couple containing the I-based species can eliminate the need for expensive catalysts and/or elevated temperatures at either of the electrodes.

In preferred embodiments, the nonaqueous solution comprises or consists essentially of iodine (e.g., I₂). Embodiments of the present invention can utilize I-based species that comprise, consist essentially of, or consist of at least two species selected from I⁻, I₂, and anions of Iₓ (x≧3), which are soluble. Particular examples of anions of Iₓ (where x≧3) can include, but are not limited to, I₃⁻, I₅⁻, and I₇⁻. Alternatively, anions of Iₓ (where x≧3) can include, but are not limited to I₂ₙ₊₁⁻, wherein n is a positive integer.

In some embodiments, a pressure regulation system is used in the sources that contain the first and/or second electrolyte to control and adjust the pressure in the headspace of the electrolyte source container. The volume of the first and second electrolyte can be controlled and adjusted, and therefore the capacity decay can be regulated, through the pressure regulation.

The purpose of the foregoing summary is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The summary is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is an illustration depicting a redox flow battery according to aspects and embodiments of the present invention.

FIG. 2 includes a graph presenting charge/discharge voltage curves against the cell capacity of a flow cell having a first cell comprising Li metal and a second cell comprising a redox active couple including I⁻ and I₃⁻, according to embodiments of the present invention.

FIG. 3 is a graph of CV curves from a flow cell electrolyte having 0.1 M LiI in 0.5 M LiTFSI according to embodiments of the present invention.

FIGS. 4A-4C include graphs depicting electrical performance of a flow cell comprising 1 M LiI in 0.3 M LiTFSI according to embodiments of the present invention.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims. The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of ingredients, properties such as molecular weight, percentages, ratios and so forth, as used in the specification and claims are to be understood as being modified by the term “about.” Unless otherwise indicated, non-numerical properties used in the specification or claims are to be understood as being modified by the term “substantially,” meaning to a great extent or degree, as within inherent measurement uncertainties. Accordingly, unless otherwise indicated, implicitly or explicitly, the numerical parameters and/or non-numerical properties set forth are approximations that may depend on the desired properties sought, limits of detection under standard test conditions/methods, limitations of the processing method, and/or the nature of the parameter or property. When directly and explicitly distinguishing embodiments from discussed prior art, the embodiment numbers are not approximates unless the word “about” is recited.

To facilitate review of the various embodiments of the disclosure, explanations of specific terms are provided herein.

A nonaqueous redox flow battery, as used herein, can refer to a type of rechargeable energy storage device in which rechargeability is provided by at least two chemical components dissolved in nonaqueous liquids contained within the system and separated by a separator or membrane. Ion transport (providing flow of ionic current) occurs through the porous separator or membrane while at least one liquid circulates in its own respective space. The nonaqueous redox flow battery does not utilize an aqueous solution in either half cell. However, an additive amount of a nonaqueous material can be utilized. Examples of additive amounts can include having less than 5 wt %, 3 wt %, and 1 wt %.

As used herein, a prior-to-charge state can refer to an RFB prior to an initial charge/discharge cycle. It can also refer to a state of the RFB after recovery of the electrolytes and prior to a subsequent charge/discharge cycle.

Disclosed are energy storage devices encompassing nonaqueous RFBs with a M/Mⁿ⁺ based redox active couple as a negative electrode/electrolyte in a first half cell and I-based species as a positive electrolyte in a second half cell configured to flow the positive electrolyte. The nonaqueous RFBs can demonstrate high cell voltage and high energy density.

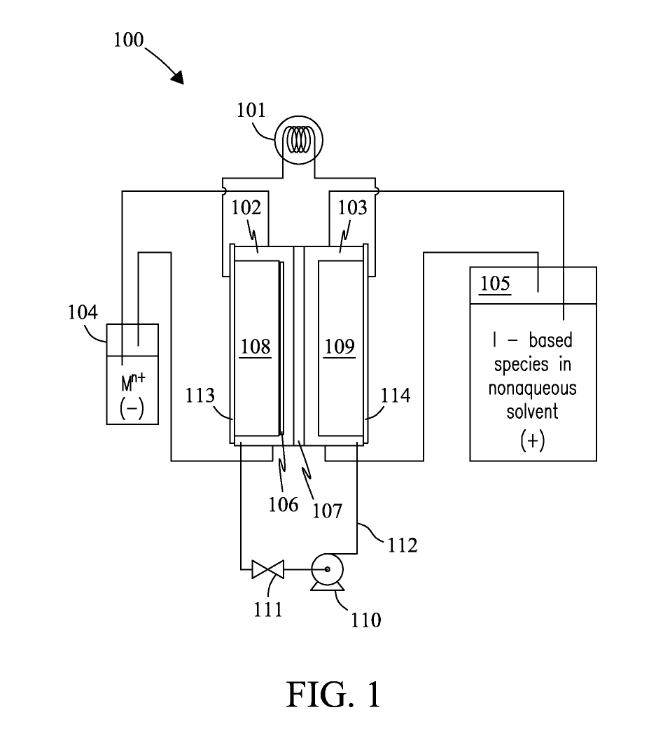

Referring to FIG. 1, a schematic depicts an RFB according to embodiments of the present invention. As depicted, the RFB has a first half cell 102 comprising M in a solid state 106 and cations of M in a first nonaqueous electrolyte solution as a first redox active couple. As depicted, the first half cell is configured to flow the electrolyte solution, although the flow configuration is optional. A reservoir 104 contains a source of the nonaqueous solution comprising M cations. The RFB also has a flow second half cell 103 comprising a second nonaqueous electrolyte solution having I-based species selected from the group consisting of I⁻ anions, I₂, anions of Iₓ (x≧3), or combinations thereof. A reservoir 105 containing the second nonaqueous electrolyte solution is depicted. A membrane or separator 107 separates the first and second half cells. The two half cells can be connected to provide an electrical supply for a load 101. The first and second half cells can further comprise electrodes 108 and 109, respectively. The electrodes can comprise different types of electrically conductive materials, such as graphite felt, graphene, and/or metal. The electrode can be porous materials or solid materials with field design. The first and second half cells can further comprise current collectors 113 and 114, respectively.

Two different ones of the I-based species compose a second redox active couple in the second half cell. A redox active couple refers to a reducing active species and its corresponding oxidized form, or an oxidizing active species and its corresponding reduced form. I₂/I⁻ and I₃⁻/I⁻ redox couple has a redox potential of ˜0.54V versus NHE. In some embodiments, the extent of oxidation is controlled by a management sub-system of the energy storage device, which limits operating voltages or charge/discharge capacity. In such instances, the I⁻ can be oxidized to Iₓ⁻(x≧3) species, rather than I₂, and the redox potential is correspondingly lower.

The first half cell can comprise one of a variety of metals. Table 1 below summarizes the redox potentials versus NHE for just some of the examples of metal/metal ion redox couples. It also provides the corresponding flow cell potentials for each metal when operated with an I₂/I⁻ redox couple. These chemistries all exhibit a cell potential that is greater than or equal to 2.2V.

| Metal | Li | Na | Mg | Al | K | Ca | Cs | Ba |
|---|---|---|---|---|---|---|---|---|
| Redox | −3.04 | −2.71 | −2.37 | −1.66 | −2.93 | −2.87 | −3.02 | −2.91 |
| Potential | | | | | | | | |
| Cell | 3.58 | 3.25 | 2.81 | 2.2 | 3.47 | 3.41 | 3.56 | 3.45 |
| Potential | | | | | | | | |
| No. of | 1 | 1 | 2 | 3 | 1 | 2 | 1 | 2 |
| Electrons | | | | | | | | |

The particular type of metal used can be involved in multiple electron transfer during charging and discharging. For example, in Table 1, metals such as Mg, Al, Ca, and Ba involve multiple electron transfers in the redox reactions. The use of metals involving multiple electron transfer is not required, but can result in increased energy density of RFBs described herein. For example, LiI has a solubility limit of approximately 1.55M in a mixed solvent of DMSO and fluoroethylene carbonate (FEC). The lithium-iodine flow battery has a theoretical energy density of ˜150 Wh/L, which is more than twice higher than the all-vanadium mixed-acid system at 2.5M (40 Wh/L). A metal species contributing multiple electrons can exhibit a significantly higher theoretical energy density at the same solubility. For example, although a cell using MgI as the electrolyte will have a slightly lower cell voltage, its theoretical energy density will be ˜233 Wh/L at the 1.55M concentration due to the two electron redox reaction. In some designs, additional source of iodine ions may needed to be added. Alternatively, it could exhibit the same theoretical energy density at a lower solubility.

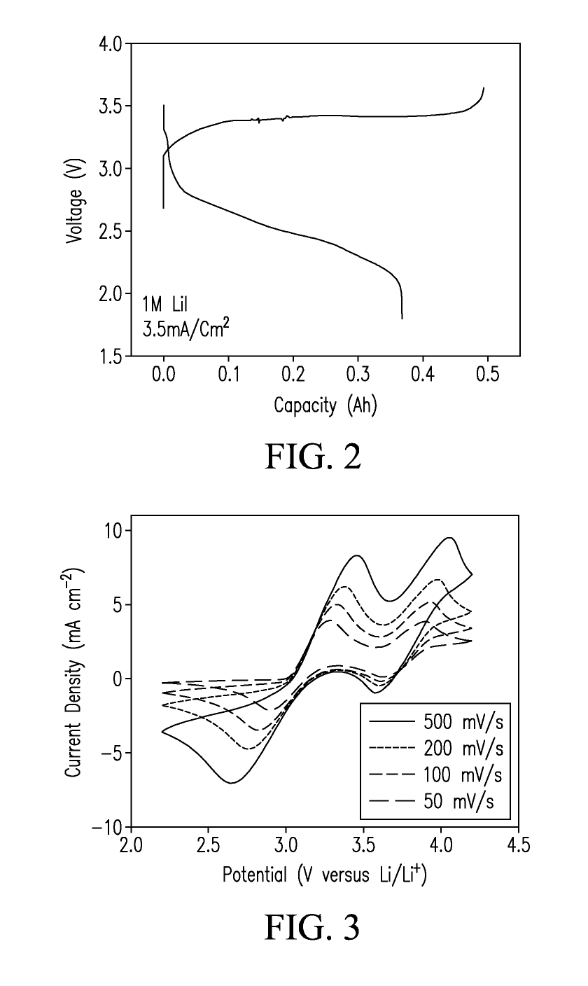

Referring to FIG. 2, a graph presents the charge/discharge voltage curves of a flow cell having a first cell comprising Li metal and a second cell comprising a nonaqueous electrolyte solution having I-based species. The flow cell was charged to limit oxidation such that the redox active couple comprised I⁻ and I₃⁻. The flow cell was constructed by a hybrid anode, a graphite felt cathode, and a polyethylene-based porous separator in between. The hybrid anode comprised electrically connected Li metal and graphite felt directly stacked on top. The catholyte contained 1.0 M LiI in a 0.5 M lithium bis(trifluoromethanesulfonyl)imide (LiTFSI) supporting electrolyte in a solvent mixture of ethylene carbonate (EC)/ethyl methyl carbonate (EMC)/triglyme at a weight ratio of 2:1:7 with a 15wt % FEC as the SEI-stabilizing additive. The flow rate was 40 mL/min on the catholyte side and zero on the anode side. The current density was 3.5 mA/cm² and the voltage limit was 1.8-3.65 V. The charge and discharge capacities were 24.24 Ag/L and 17.53 Ah/L, respectively. The charge and discharge energies were 82.3 Wh/L and 44.2 Wh/L, respectively. The Coulombic efficiency, voltage efficiency, and energy efficiencies were 72%, 74%, and 54%, respectively.

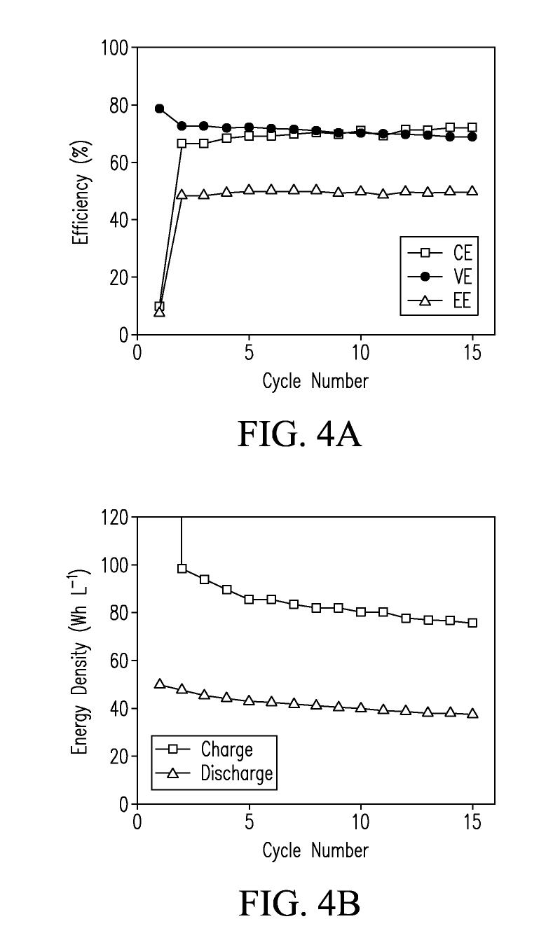

Referring to FIG. 3, a graph contains cyclic voltammetry (CV) curves from a similar flow cell having 0.1 M LiI in 0.5 M LiTFSI. The CV curves were obtained at different scan rates with a Pt/Li/Li three-electrode configuration. The curves show the two redox couples: I⁻/I₃⁻ (at the relatively lower potential) and I₃⁻/I₂ (at the relatively higher potential).

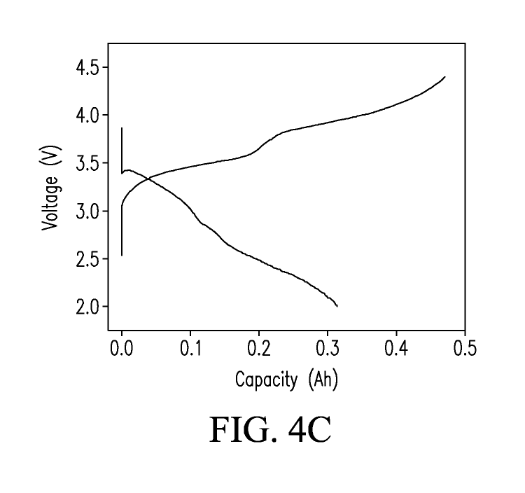

Referring to FIGS. 4A-4C, electrical performance data is shown from a flow cell comprising 1 M LiI in 0.3 M LiTFSI. The operating voltage was between 2 and 4.4 V at a current of approximately 3.5 mA/cm². The electrolyte was flowed at a rate of 40 mL/min through the positive half cell. In FIG. 4A, as in FIG. 3, two plateaus can be observed. Referring to FIG. 4B, the CE and VE are roughly 70%, while the EE is roughly 49%. FIG. 4C shows the charge and discharge energy density up to 15 cycles.

The inventors find that the use of I-based species as the electrolyte in nonaqueous RFBs can enable the use of low-cost separators or membranes due at least in part to the reduced corrosion of the I-based-species-containing electrolyte solution. Examples of porous separators can include, but are not limited to, Celgard® PP or PE separators, Tonen® separators, Daramic® PE/silica separators, Amer-Sil® PVC/silica separator, PTFE/silica separators, and TAMI® ceramic filter membranes. Examples of porous membranes can include, but are not limited to, sulfonated fluoro-polymers and copolymers, sulfonated polyolefin polymers, sulfonated aromatics-containing polymers, (Nafion , FumaTech , Selemion , Neosepta , and Femion). Fast-ion conductive materials including solid state electrolytes like NaSiCON and LiSiCON are not encompassed by embodiments of the present invention.

In some embodiments, the electrolyte in the first and second half cells differ. In such instances, the separator is preferably an ion exchange membrane. Other embodiments described herein can employ a single electrolyte, MIₙ, in both first and second half cells. Preferably the first and second electrolyte solutions are a common solution when the RFB is at a prior-to-charge state, even though compositions may change during and after charge/discharge cycles. Separation between the first and second half cells is accomplished using a porous separator or membrane. Preferably, differences in concentrations of active species across the separator or membrane are minimized at least in order to reduce crossover transfer between half cells. For example, the concentration of metal cations can be substantially equivalent in both half cells and the concentration of I-based species can be substantially equivalent in both half cells. In some embodiments, mixing of the positive and negative electrolytes can occur periodically via a conduit 112 and a flow regulator. Examples of flow regulators can include, but are not limited to pumps 110 and valves 111. Mixing can restore capacity loss resulting from active species transfer between half cells.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. An energy storage device comprising a first half cell and a second half cell, the device characterized by:
the first half cell comprising a solid or molten first electrode comprising a metal (M), wherein M and cations of M compose a first redox active couple at the first half cell;
the second half cell configured as a flow cell connected to a source of a second nonaqueous electrolyte solution comprising I-based species and cations of M, wherein the I-based species are selected from the group consisting of I⁻ anions, I₂, anions of Iₓ (x≧3), or combinations thereof, and wherein two different ones of said I-based species compose a second redox active couple in the second half cell; and
A porous separator or ion exchange membrane between the first and second half cells.

2. The energy storage device of claim 1, further comprising a first nonaqueous electrolyte solution in which the cations of M are dissolved.

3. The energy storage device of claim 2, wherein the first half cell is configured as a flow cell connected to a source of the first nonaqueous electrolyte solution.

4. The energy storage device of claim 2, having a prior-to-charge state, wherein the first and second nonaqueous electrolyte solutions comprise substantially equal concentrations of cations of M and comprise substantially equal concentrations of I-based species.

5. The energy storage device of claim 2, wherein the solid first electrode comprises a slurry having particles of solid M and the first nonaqueous electrolyte solution.

6. The energy storage device of claim 5, wherein the first half cell is configured as a flow cell connected to a source of the slurry.

7. The energy storage device of claim 1, wherein a charge-carrier species is one or more of the cations of M.

8. The energy storage device of claim 1, wherein the membrane comprises a porous separator or a cation exchange membrane.

9. The energy storage device of claim 1, wherein M comprises Na, K, Cs, Mg, Ca, Ba, Al, Zn, Ga, Fe, Li, Cr, Ti, and combinations thereof.

10. The energy storage device of claim 1, further comprising a conduit connecting the first and second half-cells and a flow controller, wherein the conduit and flow controller are configured to permit or restrict circulation of electrolyte from the second half-cell to the first half-cell to react with the first solid or molten electrode to recover the electrolytes.

11. The energy storage device of claim 1, having an energy density value that is greater than 60 Wh/L.

12. An energy storage device comprising a first half cell and a second half cell, the device characterized by:
the first half cell comprising a solid or molten first electrode comprising a metal (M) and a first nonaqueous electrolyte solution in which cations of M are dissolved, wherein M and cations of M compose a first redox active couple at the first half cell;
the second half cell configured as a flow cell connected to a source of a second nonaqueous electrolyte solution having I-based species and cations of M, wherein the I-based species are selected from the group consisting of I⁻ anions, I₂, anions of Iₓ (x≧3), or combinations thereof, and wherein two different ones of said I-based species compose a second redox active couple in the second half cell;
A porous separator or ion exchange membrane between the first and second half cells;
a charge-carrier species being one or more of the cations of M; and
an energy density value that is greater than 60 Wh/L.

13. The energy storage device of claim 12, further comprising a conduit connecting the first and second half-cells and a flow controller, wherein the conduit and the flow controller are configured to permit or restrict circulation of electrolyte from the second half-cell to the first half-cell to react with the first solid or molten electrode.

14. The energy storage device of claim 12, having a prior-to-charge state, wherein the first and second nonaqueous electrolyte solutions comprise substantially equal concentrations of cations of M and comprise substantially equal concentrations of I-based species.
